(19) United States
(12) Patent Application Publication
(10) Pub. No.: US 2024/0270275 A1
(43) Pub. Date: Aug. 15, 2024

(54) STEERING WHEEL HAPTICS FOR SITUATIONAL AWARENESS

(71) Applicant: Brahmadev Sharma, Gwalior (IN)

(72) Inventor: Brahmadev Sharma, Gwalior (IN)

(21) Appl. No.: 18/568,914

(22) PCT Filed: Jun. 11, 2022
(86) PCT No.: PCT/IB2022/055427

§ 371 Date: Dec. 11, 2023

(30) Foreign Application Priority Data
Jun. 12, 2021 (IN) 202121026223

(51) Int. Cl. B60W 50/16

(52) U.S. Cl. CPC B60W 50/16; B60W 2422/00

(57) ABSTRACT

The present invention relates to providing haptic feedback to driver of a vehicle, wherein the actuators for haptics generation are mounted on steering wheel and provides haptic feedback related to vehicle traveling conditions including speed, torque, acceleration, traction, drift, road surface, etc. Also, the haptics can emulate vibration similar to older generation vehicles in modern vehicles having better isolated cabin for NVH levels. Further, the haptics can emulate vibrations similar to internal combustion engine vehicle in an electric vehicle (EV).

### FIELD OF INVENTION

The present invention relates to a haptic feedback system for driver of a vehicle.

### BACKGROUND & PRIOR ART

Modern vehicle produces very low sound and vibrations. In addition, various technologies are used for combustion engine vehicles to reduce their Noise, vibration, and harshness (NVH) levels. Modern suspension systems are capable of filtering much of the road undulations experienced inside the vehicle cabin. Further, assisted steering system also filters the tire feedback to the driver. Lower NVH levels and improved suspension system provides isolated cabin space for passengers, enhancing their comfort level. However, such isolation reduces situational awareness of the driver (reduced sense of vehicle speed or traction).

Many drivers while driving the vehicle enjoy sound and vibrations produced by the combustion engine. Assisted steering system (electrically or hydraulically assisted steering) enhances driver comfort but it does not provide appropriate feedback as a non-assisted steering system does. The assisted steering system reduces driver's sense of connection with the road and sense of forces the tires are experiencing. These factors hamper driver's situational awareness and enthusiasm towards driving.

Further, the drive train of electric vehicles (EVs) are silent in nature compared to the combustion engines. To address low sound emission form EVs, external and internal speakers provide artificially generated engine noise, to alert pedestrians and to provide feedback to the driver. However, artificially generated sound is not enough for enhancing driver experience and situational awareness.

Modern vehicles are equipped with alert mechanism, which shake or vibrate the steering wheel column. However, these vibration alerts are devised for catching drivers' attention towards an event (i.e. driver feeling dizzy, driver's hand are not on steering wheel in an autonomous/semi-autonomous vehicle etc.).

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only and is not intended to limit the scope of the present application.

The invention uses a haptics system which precisely creates vibrations/haptic/taptic at the surface of steering wheel of the vehicle to provide various feedbacks related to vehicle driving conditions to the driver.

In an embodiment of the invention, a steering wheel of a vehicle houses at least one vibration generator. The vibration generator is configured to provide vibrational (haptic) sensation at the portion of the driver's hands, which is in contact with the steering wheel. A controller unit monitors speed of the vehicle and controls the vibration generator to produce haptic feedback proportional to the speed of the vehicle. Alternative to speed of the vehicle, the haptic feedback can be proportional to either of a) engine/motor torque, b) engine RPM (rotation per minute) or c) acceleration of the vehicle.

In another embodiment of the invention, the steering wheel of the vehicle houses multiple vibration generators (preferably inside rim of the steering wheel), wherein the vibration generators may have similar or dissimilar vibration characteristics (i.e., vibration frequency range, intensity or direction of vibration). The controller unit receives at least one of the speed, acceleration, engine torque data from one or more sensor units in real-time and provides control signals to the multiple vibration generators for generating haptic feedback corresponding to the received real-time data.

In another embodiment, the multiple vibration generators emulate or provide feedback of drivetrain (engine or motor) operation in real-time. Wherein, the drivetrain operation includes torque produced by the drivetrain, currently engaged gear, load observed by the drivetrain and speed of the vehicle. The multiple vibration generators can also be controlled to emulate different gears by selectively enabling or disabling the vibration generators (i.e., higher the gear ratio a smaller number of active vibration generators). Wherein, the individual vibration generators may generate slightly out of sync vibrations for more convincing emulation.

In another embodiment, an array of vibration generators is housed in the steering wheel (preferably inside rim of the steering wheel). Wherein individual vibration generators of the array of vibration generators are placed at certain distance from each other and create vibrations at a small area of steering wheel surface (localized vibrations/haptics). A layer of material (i.e. plastic, rubber, wood, cloth etc.) can be placed between the space for providing support to the individual vibration generators and to provide isolation of vibration between the individual vibration generators of the array of vibration generators for improving the localized vibrations. Alternatively, a left and a right array of vibration generators are placed at the rim of the steering wheel at locations where generally driver's left and right hand grips the steering wheel (commonly known as 10 10 grip).

In another embodiment, at least one sensor unit measures road surface below the vehicle (undulations, road smoothness or roughness, topography of road section, road material like tarmac, gravels, grass, snow, sand etc.) or grip of the tires (traction, wheel slip, lateral wheel slip etc.) in real-time. The controller receives the measurement and actuates the vibration generator array/arrays based on the received measurement. The haptic pattern intuitively provides haptic feedback of actual conditions vehicle is experiencing while being driven.

In another embodiment, the haptic patterns created by the controller are based on the sensor data, to control the array of vibration generators which cause localized vibrations emulating road surface conditions (similar sensation but at reduced intensity) to as it feels with non-assisted steering wheel and may be with harder suspension setup or with less cabin insulation (similar to older generation or traditional vehicles). The localized vibrations, unlike vibrating whole steering wheel at same frequency and intensity, cause individual vibrations at multiple small areas at the surface of the steering wheel.

In another embodiment, a left sensor and a right sensor monitor road surface near the vehicle's left and right front wheel respectively. Alternatively, one or more parameters related to left and right wheel are measured (i.e. traction, wheel slip). Accordingly, haptic patterns are generated by the left and right array of vibration generators to emulate different road sensation as felt by the left and right front wheels of the vehicle. Instead of the left and right sensors, a common sensor capable of wide enough coverage of monitoring area from left to right front wheels of the vehicle, can also be used to monitor road surface.

In another embodiment, measurement of vertical movement of the left and right wheel with respect to the vehicle chassis or undercarriage can be used to generate vibration sensation to represent road condition at left and right side of the steering wheel respectively. Alternatively, an average of movement data of left and right wheel can be used for haptic feedback (no separate left-right hand feedback). Alternatively, Measurement done at one wheel (preferably driver side front wheel) can be used to generate road condition sensation. In another embodiment, the controller utilizes data from vehicle's electronic control system (I.e., anti-lock braking system, traction control system, electronic stability control etc.) for generating vibration patterns using array of vibration generators to provide haptic feedback emulating skid conditions, tire locking or low traction conditions.

In another embodiment, one or more motion sensor (i.e., MEMS, accelerometer, gyroscope etc.) measures speed, acceleration or vibrations of the vehicle. To measure vehicle vibrations the one or more motion sensor is placed outside of the passenger cabin preferably in the engine compartment. Alternatively, the motion sensors are placed at multiple locations of the vehicle and measures vibration at different locations of the vehicle. Motion sensors placed on wheels of the vehicle also provide measurement of vertical movement of the wheel or tire. The controller receives data from one or more motion sensors and controls generation of vibration patterns (haptic feedback patterns) based on the received motion sensor data. While using one or more motion sensors, rate of change of vertical movement is calculated and used as a signal to filter out signals generated due to descent or ascent of road (slope).

In another embodiment, one or more microphones are placed in engine compartment or in the exhaust system of the vehicle. The one or more microphones generates electrical signal corresponding to engine noise. The control receives input from the microphone and controls haptic feedback based on the received microphone signal. A combination of motion sensors and microphones can also be used for measuring NVH (Noise, vibration and harshness) levels of the vehicle outside the passenger cabin. The controller receives signals from motion sensor and microphone and based on combined signals generates haptic feedback patterns. Alternatively, a microphone can be placed at rear of the vehicle, a processor receives microphone inputs and intelligently filter in if a horn is blown by a following vehicle while filtering out other noises. If a horn sound is detected the processor provides input to the controller to control haptic feedback indicating horn sound detection to the driver.

In another embodiment, the controller also monitors geolocation of the vehicle and/or navigation data (from Google map, Here map etc.). Based on the geo-location and/or navigation data the controller adjusts haptic feedback intensity (I.e., at a straight highway with higher speed limits selecting a lower ratio of speed/torque/RPM vs. haptic feedback. For high traffic density locations, selecting a lower ratio of speed/torque/RPM vs. haptic feedback. At locations having roads where drivers can enjoy driving (such as twisted and curvy roads) selecting a higher amount of haptic feedback etc.).

The present invention provides precise haptic feedback (mild or low intensity) and can be combined with the existing alert systems, which provides steering column vibrations (comparatively higher intensity vibrations).

### BRIEF DESCRIPTION OF DRAWINGS

To clarify various aspects of some example embodiments of the present invention, a more particular description of the invention will be rendered by reference to specific embodiments thereof, which are illustrated in the appended drawings. It is appreciated that these drawings depict only illustrated embodiments of the invention and are therefore not to be considered limiting of its scope. The invention will be described and explained with additional specificity and detail through the use of the accompanying drawings.

FIG. 1 is a schematic block diagram of haptics system

FIG. 2 is a diagram of Eccentric rotating mass vibration motor

FIG. 3 is a diagram of linear resonant actuator

FIG. 4 is diagram of piezoelectric haptic generator

FIG. 5 is a diagram of steering wheel

FIG. 6 is a diagram of steering wheel showing segments having array of haptic

generators

FIG. 7 is a diagram showing internal structure of the segment having array of haptic generators

FIGS. 8a to 8c shows grid array of vibration generators

FIGS. 9a and 9b shows an overview of undercarriage-mounted sensors for measuring road undulations

FIG. 10 shows a system for measurement of shock absorber travel FIGS. 11a to 11d shows various feedback curves

### DETAIL DESCRIPTION OF THE DRAWINGS

Some embodiments of this disclosure, illustrating all its features, will now be discussed in detail. The words and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the 25 practice or testing of embodiments of the present disclosure, the exemplary systems and methods are now described. The disclosed embodiments are merely exemplary of the disclosure, which may be embodied in various forms.

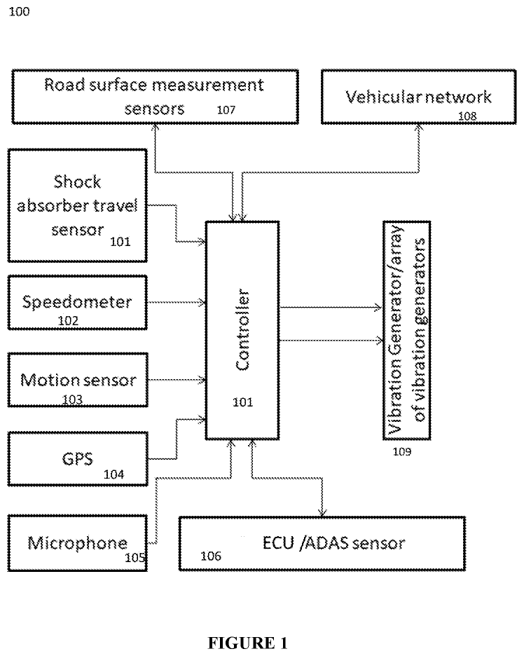

FIG. 1 is a schematic block diagram of a haptics system 100. The system includes a controller 101, electrically connected and capable of receiving signals/data from at least one of a shock absorber travel sensor 101, a vehicle speedometer 102, a motion sensor unit 103, a GPS 104, a microphone unit 105, a vehicle electronic control unit or vehicle's advanced driver-assistance systems (ADAS) 106, a road surface measurement unit (sensors) 107. The controller is connected with a vehicular network 108 (i.e. CAN bus, vehicular Ethernet, Flex ray etc.). The vehicular network 108 enables controller 101 to communicate with various vehicle systems and vehicle telematics/infotainment system (not shown). The controller is electrically connected with the vibration generator unit 109 and provides actuation/control signals to vibration generator unit 109. The vibration generation unit 109 includes one or more electric vibration generation transducer. The vehicle controller 101 have an electric connection with the various sensors and vibration generation unit. Alternatively, the vehicular network (i.e. can bus, flex ray or automotive Ethernet etc.) can facilitate the connection with various sensors and vibration generation units. The schematic block diagram is non-limiting overview of system and may have more or less input/output units or distributed control units.

The controller 101 includes either of microcontroller, microprocessor, application-specific integrated circuit (ASIC) or System on chip (SoC) and capable of executing executable program codes (software or firmware) stored in a memory. The controller 101 can be a part of ECU or vehicle's onboard processor.

The vibration generator unit 109 includes one or more vibration generator transducer (Herein after referred as vibration generator), wherein the vibration generator produces mechanical vibrations when subjected to an electrical signal input. Non limiting examples of vibration generators includes:
a. Eccentric rotating mass vibration motor (ERM). The ERM uses a small unbalanced mass attached to shaft of a DC motor, when the mass is rotated by the motor the mass creates a force that translates to vibrations.
b. Linear resonant actuator (LRA) is a precision vibration motor that produces an oscillating force across a single axis. The LRA drives a magnetic mass up and down against a spring to generate vibrations. A variation of LRA is Taptic engine developed by Apple Inc. In principle LRA is similar to an audio transducer (speaker).
c. Piezoelectric haptic generators/actuators generate vibration when voltage signal is applied across the piezoelectric element.

Apart from the above-mentioned types of vibration generators, one or more low frequency speakers (sub-woofers) can be used.

The above-described vibration generators are exemplary and not to be limited by only these types of vibration generators any other vibration generation means can be used for creating vibrations/haptic/tactile feedback.

The above described types of vibration generators can be used alone or in combination of two are more types for creating desired vibration patterns.

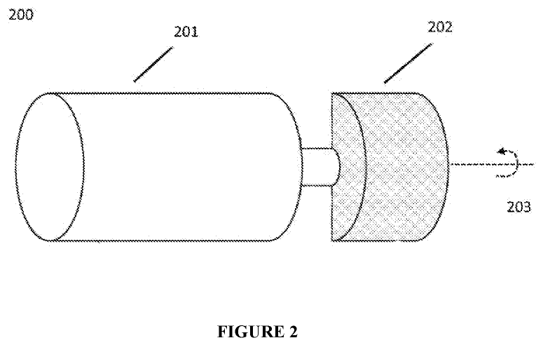

FIG. 2 is a diagram of the ERM vibration motor 200. The ERM vibration motor 200 includes an electric motor 201 (preferably DC induction motor) and an unbalanced mass 202 which is mechanically attached at a shaft of the electric motor 201. In FIG. 2, 203 represents rotation axis of the electric motor 201. When appropriate voltage (electric signal) is applied to the electric motor 201, the electric motor 201 rotates the unbalanced mass 202, which in turn causes mechanical vibrations.

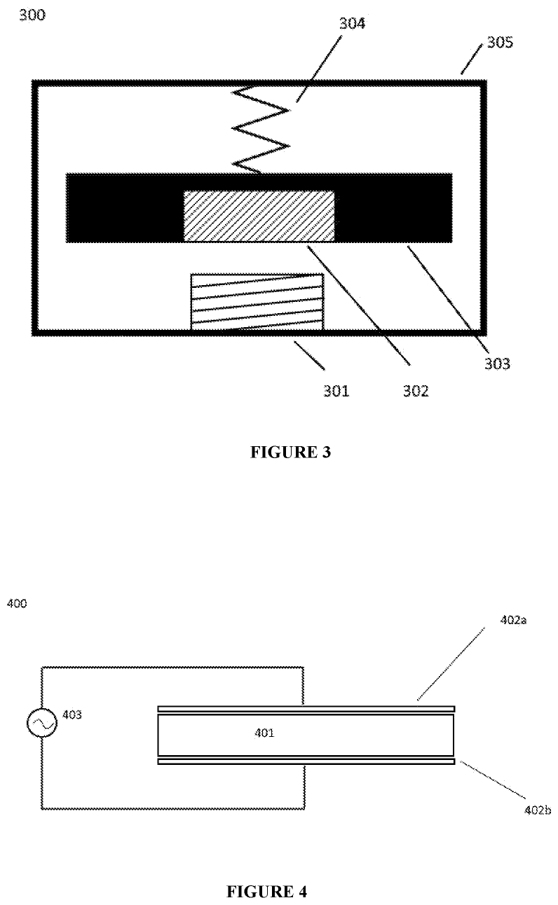

FIG. 3 is a diagram of LRM vibration motor 300. The LRM vibration motor 300 consist a magnetic coil 301, a permanent magnet 302, a mass 303 and a housing 305. The mass 303 is mechanically coupled with the permanent magnet 302 and suspended/kept in place by at least one spring 304. When a signal is applied across the magnetic coil 301 it causes a linear motion (to-and-fro motion) across an axis 306 in the magnet 302 and mass 303 to create vibrations. An improved version of the LRM is created by the Apple Inc. as Taptic engine.

For purpose of this invention, instead of vibration generator a linear actuator can be used, wherein the linear actuator has a shaft attached to the magnet (instead of the mass 303. The shaft moves in to and from motion when actuated and extends out from the housing. The shaft reaches up to the surface and push (poke) against the skin of driver's hand. Shafts disclosed in this invention works similar to the MIT lab's inForm screen technology.

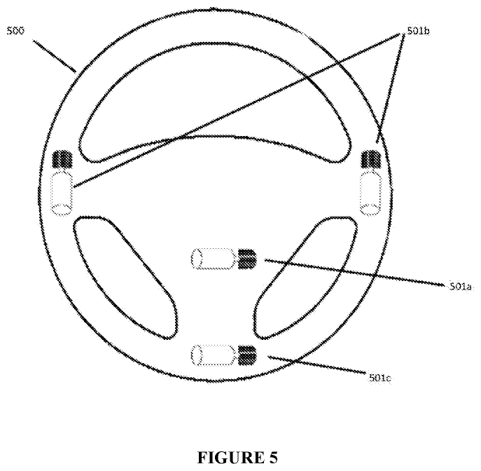

FIG. 4 is a diagram of piezoelectric haptic generator 400, having a piezoelectric material 401 which expands or contracts when an electrical charge is applied, creating movement and force. When differential voltage (electrical signal) 403 is applied across both ends of a piezoelectric material via electrodes 402a and 402b, a vibration is produced by bending or deforming.

FIG. 5 shows the steering wheel 500 having a vibration generator 501a inside the steering wheel spoke. The vibration generator 501a is placed near the center of the steering wheel 500 or near the center line of the steering wheel 500. The vibration generator 501a is preferably placed in such a way that it did not interfering with the air bag (not shown in figure) and other electronic units housed inside the steering wheel 500. Alternatively, the vibration generator(s) can be placed inside the wheel at peripheral part of the steering as 501c (at the center line of the steering wheel 500). In alternative embodiment, a pair of vibration generators 501b are placed at both side of steering wheel (commonly known as 10-10 position where the driver's hands rests/placed on the steering wheel). Each vibration generator of the pair of vibration generators 501b are controlled independently to provide independent left and right haptic feedback. Alternative to the pair of vibration generators 501b, a pair of vibration generator arrays can be used. The placement of vibration generator in FIG. 5 are exemplary only and not to be restricted to only these locations, any other location and orientation inside the steering wheel can be used for mounting the vibration generator.

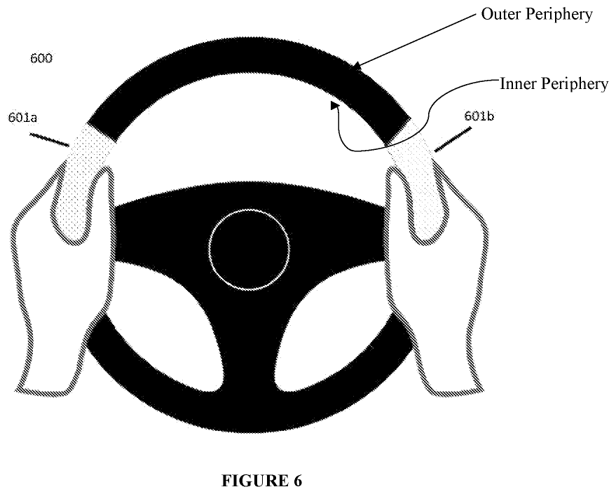

FIG. 6 shows a generic hand position (10-10 position) of driver at the steering wheel. Where steering wheel sections 601a and 601b houses pair of vibration generators 501b or pair of vibration generator arrays. Alternatively, the vibration generator array can stretch along the complete circle of the wheel and not restricted to individual sections of the wheel. In addition, the array can have span across upper part of steering wheel forming a semi-circle (not shown in the FIG. 6). Section 601a and 60b is covered with soft material such as foam, rubber, lather and beneath the soft material vibration generator arrays are placed. Soft material reduces harshness of vibrations and provides haptic feedback. The soft material also provides damping effect so that vibrations from individual vibration generator do not affect vibrations of other nearby vibration generators, hence vibrations remain localized to a small section of steering wheel surface. In case the vibration generator array is based on LRA 300, to increase the effect of haptic feedback a small shaft can be attached in line with the axis 302, to the moving mass 303 or attached to the permanent magnet 302. The shaft extends out of the housing 305 and physically contacts with the soft material.

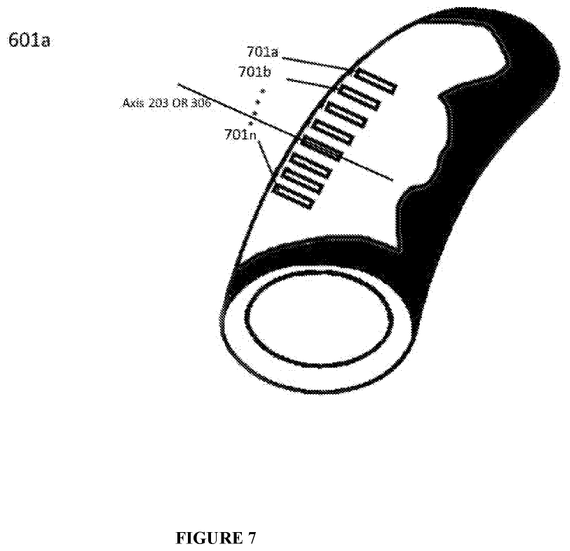

FIG. 7 shows internal arrangement of the steering wheel section 601a. The steering wheel section 601a houses a linear array 701 of the vibration generators (701a, 7021 . . . 701n), wherein the vibration generators (701a, 7021 . . . 701n) are arranged in a linear fashion at constant distance from each other. In the figure linear array 701 is placed inside the steering wheel and arranged along the outer periphery of the steering wheel. Vibration generators (701a, 7021 . . . 701n), are mounted on a frame having separate compartments for each vibration generator to create local vibration zones. Vibration of each vibration generator (701a, 7021 . . . 701n) is controlled by the controller 101 independent to other vibration generators. The figure shows the array at the outer periphery of the steering wheel; however, the configuration of the array is not limited to the outer periphery and can be placed at inner periphery of the wheel or can be faced at any direction inside the steering wheel section. In case of LRA 300 (or taptic engine), the vibration generator axis is arranged perpendicular to the wheel periphery to generate precise haptic feedback.

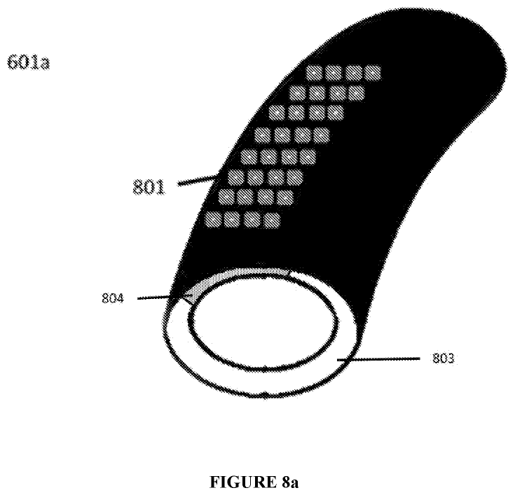

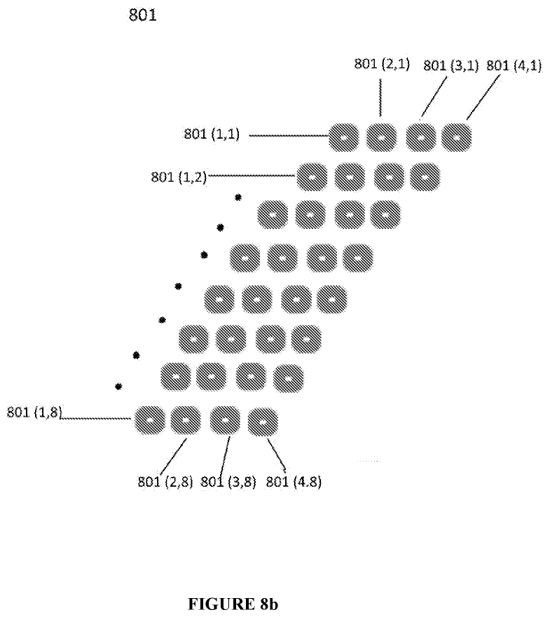

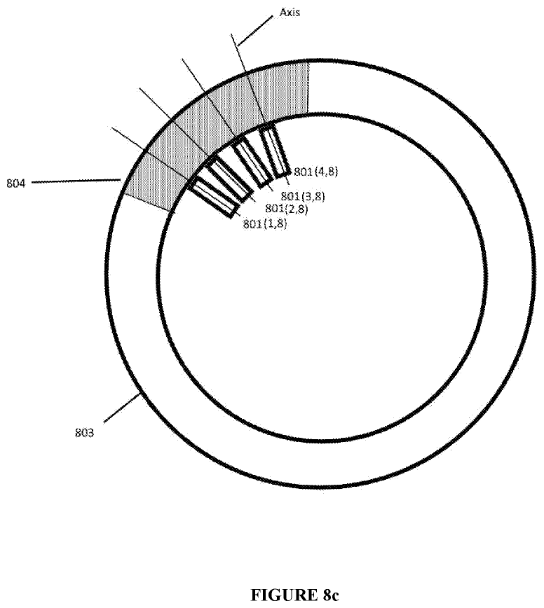

FIG. 8a shows an alternative internal arrangement of the steering wheel section 601a, having a grid array 801 of vibration generators. The vibration generators in the grid array 801 are arranged in similar fashion as in linear array but instead of one line of vibration generators, the generators are arranged in m x n grid pattern (figure shows local zones created by a 8×4 grid). If LRA 300 is used as vibration generators, for maximum effect of haptic feedback, the vibration generators are arranged having axis 306 perpendicular to the surface of the steering wheel. The figure shows partial coverage of hand grip portion of the 601a; however, the grid array can arrange to cover entire surface (360 degree) of the steering wheel section 601a to provide haptic feedback at all the points of driver's hand having contact with the steering wheel. Each vibration generator of the array 701 or 801 are individually addressable and individually controllable by the controller 101.

FIG. 8b shows grid of vibration generators (or local zones for the vibration generators) having vibration generators from 801 (1,1) to 801 (4,8) in the grid of 8×4.

FIG. 8c is a cross section of the steering wheel section 601a showing a row of the vibration generators of the grid array 801. Portion 803 is made of hard material which is commonly used for steering construction (i.e. metal or plastic), while section 804 is the soft material. A frame (not shown) provides support for mounting the vibration generators 801.

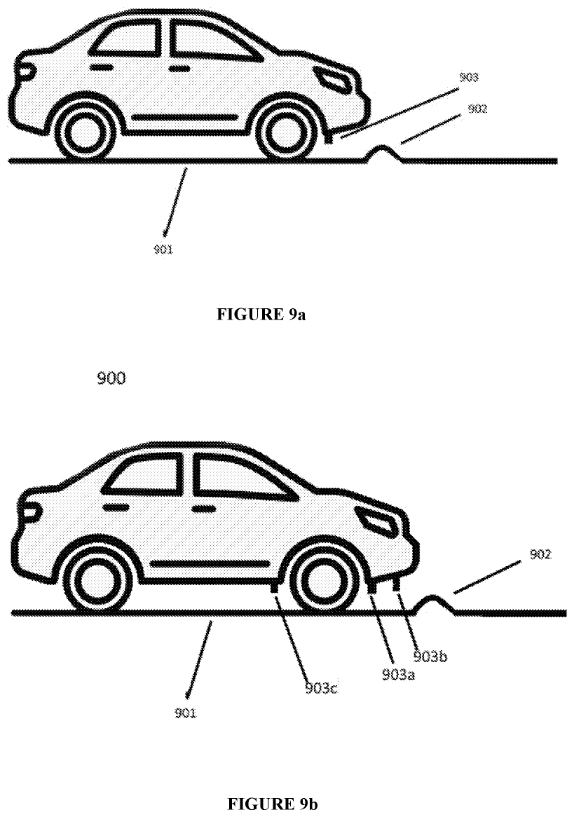

FIG. 9a shows a vehicle 900 traveling over a road 901, the road 901 having a bump (road irregularity) 902. The vehicle 900 has a sensor unit 903 mounted on the undercarriage of the vehicle, the sensor unit 903 faces towards the underlying section of the road 901 and measure road irregularities in real-time. The sensor unit 903 includes one or more sensors. The sensor unit 903 is preferably mounted near the driver side front wheel. Alternatively, a pair of sensors are mounted near each of the left and right front wheels to observe underlying road surface near left and right front tires of the vehicle 900, respectively. Alternatively, the sensor unit 903 can be mounted at any location on the vehicle 900, facing either underlying road section or facing towards road section ahead of the vehicle (facing front of the vehicle). In case the sensor unit 903 facing the front of the vehicle 900, road surface ahead of the vehicle is scanned which is at a certain distance from front wheels at the time of measurement. The certain distance is based on the position of the sensor unit 903 and view angle (measurement angle) of the sensor unit 903. The controller 101 dynamically calculates a first time delay based on the certain distance and the travel speed. The controller 101 provides signal for haptic feedback by inserting the calculated first time delay into the control signal so that haptic feedback synchronizes with the road irregularity when front wheels of the vehicle 900 encounter the irregularity 902.

FIG. 9b shows the sensor unit 903 having two or more sensors (i.e. 903a, 903b, 903c) placed at a distance apart (or at fixed intervals) from each other. The two or more sensors are arranged in a line having direction from front to back of the vehicle. A pair of two or more sensors for left and right front wheels can be used for providing individual left and right hand haptic feedback. Based on the time difference between measurement/observation of same surface irregularity by different sensors in the two or more sensors, speed of vehicle is calculated or in other words movement velocity over road surface is measured.

The sensor unit 903 can include one of the LIDAR, radar, ultrasound, visual/ToF camera etc. In one of the implementations, the sensor unit 903 measures real-time distance of undercarriage of the vehicle 900 and underlying road surface. Alternatively, a depth map of underlying road section is generated in real-time (at sufficiently high or at a dynamic refresh rate) which represents details of various road surface irregularities. Further, sensor unit 903 can detect road surface property data (density, softness, liquid on surface etc.) to identify actual surface properties such as sand, gravel, grass, mud. Alternatively, vehicle's electronic control unit 106 can provide the road surface property data. The haptic feedback is dynamically adjusted based on the real-time depth map of the road surface and/or the road surface property data. Road surface property data can be acquired using radar or ultrasound sensors or data from the existing vehicle systems such as Land Rover's Terrain Response systems which intelligently identify the road surface conditions. In case of road irregularities caused due to soft element such as grass, the irregularity is neglected to achieve realistic feedback (as soft element compresses when tire move over them, effectively vehicle experience flat surface only).

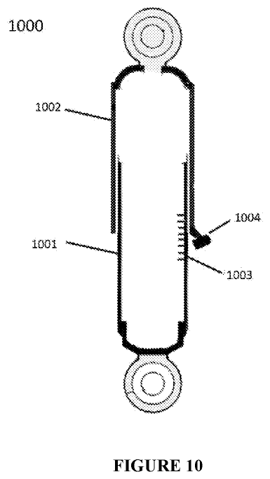

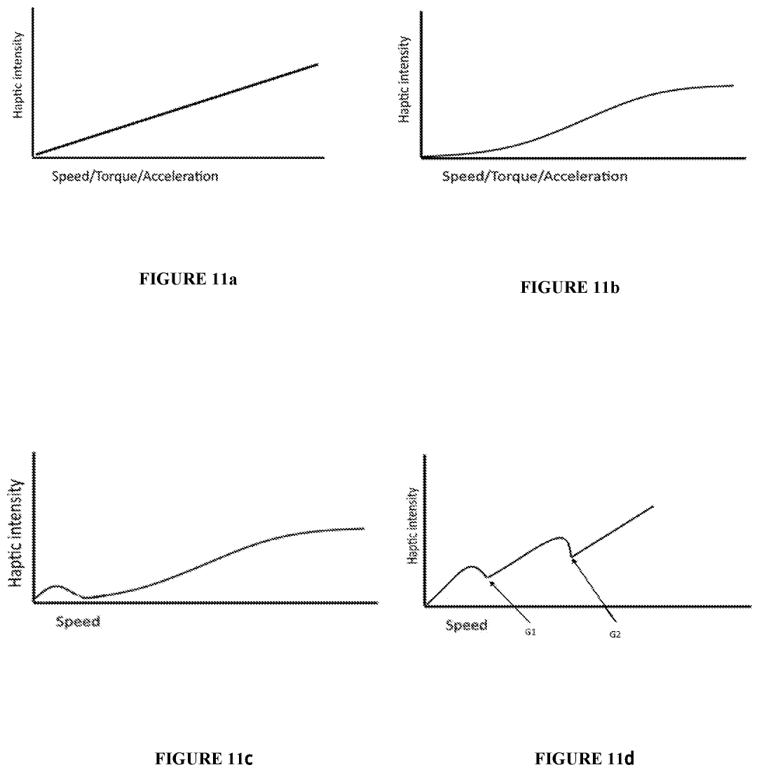

FIG. 10 Shows hydraulic unit 1000 of the shock absorber assembly, having an inner cylinder 1001 which slides over an outer cylinder 1002 as the shock absorber compresses/decompress to absorb road irregularities while vehicle is traveling. To measure the movement of the shock absorber optical markings 1003 are placed over the inner cylinder and an optical sensor 1004 attached over outer cylinder (or any other fixed location at vehicle undercarriage) facing the point where outer cylinder ends to read the markings. By reading the markings vertical travel of the shock absorber (due to road surface irregularities) is measured and corresponding feedback is generated by the controller. Instead of optical markings electrical or mechanical markings/grooves with appropriate reader can be used. Alternatively, a linear potentiometer can be integrated along with the shock absorber which provides output indicating displacement of inner cylinder inside the outer cylinder.

### Haptic (Vibration) Feedback Patterns

For ERM vibration motor 200, haptic feedback is controlled by the controlling rpm of ERM motor 200. In case of LRM vibration generator 300 or piezoelectric haptic generator 400, vibration per second and vibration intensity can be independently controlled by controlling frequency of signal and amplitude of the signal.

For the haptic feedback implementation, as shown in the FIG. 11a, vibration intensity or vibration rate is linearly proportional to the either of the speed of the vehicle, torque of the vehicle or acceleration of the vehicle or any combination of speed, torque and acceleration can be used. Alternatively, the haptic feedback curve can be nonlinear, where initially haptic intensity rises slowly at low value of speed/torque/acceleration and after a predefined value the haptic feedback rises rapidly, as shown in the FIG. 11b. Alternatively, the feedback intensity can be varied based on the driving manner. When vehicle is being driven in enthusiastically providing high intensity of feedback and while driven in calm manner providing low intensity feedback. A combination of various parameters such as speed, torque, acceleration, pedal and steering inputs etc. can be used to judge whether driver is driving in calm manner or driving enthusiastically.

For electric vehicles (EV) a feedback is required when vehicle just start to move (due to no sound and vibrations of EV, driver may not recognize vehicle is start rolling). Hence, for EV, slightly higher haptic feedback is generated at very low speed to provide feedback when vehicle starts to move, as shown in FIG. 11c. Further, vibrations similar to vibrations generated by an engine idling condition of a combustion engine vehicle, can be provided by haptic feedback when the electric vehicle is on but not moving.

For the combustion engine vehicles, vibration intensity can be proportional to the engine RPM (rotation per minute). Further, gear shifts (for combustion engine vehicle) can also be included in the feedback, as shown in FIG. 11d, wherein the feedback is provided for gear change operation (G1 and G2).

In another implementation of haptic feedback, real-time haptic signal is generated based on road surface undulations (road irregularities) as experienced by the driver side front wheel. Alternatively, haptic feedback at sections 601a and 601b are generated as per the road undulations experienced by corresponding left and right front wheels. While using linear array 701 or grid array 801, feedback is improved by adding a motion factor with the feedback. Motion factor for example, in case of a road irregularity 902 encountered by the driver side front wheel, first actuating vibration generator 701a then after a second time delay (either fix time delay or dynamically calculated time delay) vibration generator 702b is actuated and then 702c and so on till the 701n to create a perception of passing over the irregularity (something like Mexican wave or stadium wave). Similarly, vibration generators 801 (1,1) to 801 (1,4) (first row of the grid array) are actuated first and after the second time delay, vibration generators 801 (2,1) to 801 (2,4) are actuated, followed by the other rows of the vibration generators. The second time delay is dynamically calculated based on the vehicle speed. Alternatively, an instantaneous haptic feedback is generated by single vibration generator or all elements of array (or independently by left and right vibration generator) and after a time delay when the rear wheel passes over the irregularity, a second feedback is generated. The passing of rear wheel over the irregularity can be either calculated by distance between front and rear wheels and the speed of the vehicle or a separate set of sensors can be used for the sensing irregularity beneath the rear wheel.

In case of road depth map is used as an input, the sensor captures a section of road beneath the vehicle or in front of one of the front wheels. The captured section is segmented into a virtual grid where each segment of the road features from the section of the virtual grid is used to drive corresponding vibration generator of the grid 801 by the controller 101. The process is performed at sufficient frame rate to properly capture road section while vehicle is traveling over the road. To preserve computation power a low refresh rate for sensor can be selected while an artificial intelligence unit artificially generates data for feedback between two frames.

A combination of vibration generators tuned for different frequency range can be used for generation of complex haptics patterns. Alternatively, different types of vibration generators (I.e. LRA, ERM etc.) can be used for generation of complex haptics patterns. In a non-limiting example, LRA 300 are used for providing haptics corresponding to the road surface while ERM 200 provides haptics corresponding to the speed of the vehicle.

Further, the grid array can emulate a slip or drift condition by using data from an optical/laser sensor placed at the undercarriage near the rear tire or axel. The optical sensor monitors travel direction of the vehicle by scanning movement of road surface beneath the vehicle (similar to speckle movement detection by optical mouse). One or more motion sensors (such as accelerometer or gyroscope) can also detect drift conditions (loss of lateral grip or about to lose lateral grip by tires). Alternatively, data from existing electronic control unit 106 (such as traction control or electronic stability control systems) can be used. The controller generates actuation of grid array based on the received drift condition data. Drift conditions are emulated by horizontally (i.e. from 801 (1,n) to 801 (4,n)) or diagonally moving the actuation signal (similar to the Mexican wave) wherein the angle of the diagonal is based on the magnitude of the drift. For example, if rear tires have a slip direction towards right, actuation signal applied first or 801(4,1), then 801(3,2) then 801(2,2) and so on; same is applied with other rows of the grid array 801.

Apart from emulation of vibrations of a traditional vehicle, the present invention also enables to generate various custom/pre-designed vibration patterns to indicate various situations wherein the vibration patterns are designed for specific situations related to vehicle's traveling conditions and not represents the actual body vibrations of a vehicle having non-assisted steering wheel/stiffer suspension, less cabin insulation etc.

The above haptic feedback patterns are non-limiting examples and various modifications/combinations of feedback patterns can be used to provide different feedbacks for different conditions. Other than the exemplary feedbacks, steering haptics can provide feedback for notification and alert signals such as blind spot alerts, parking assist, proximity alert, door open status alert, alerts from smartphone or infotainment system, tire pressure alert, steer angle, alerts from passenger monitoring system etc.

An AI/machine learning model can be used for generating complex vibration/haptics patterns. Wherein data from various road surface conditions and vehicle driving conditions can be used as input and corresponding vibrations measured inside cabin of a traditional vehicle (who's vibration characteristics are desired for emulation) are gathered. The machine learning model can be trained by collecting data for vibration patterns generated in responses of various test signals applied to vibration generator/array of vibration generator.

The steering wheel also includes touch sensors capable of sensing skin contact. The controller uses the skin contact location data to fine tune the haptics pattern and only actuates the vibration generators which are under/near the skin contact area in other words activate only those haptic points where driver's hands are actually touching the steering wheel.

Alternative to steering wheel, the vibration generator or array of vibration generators can be placed under the driver seat where driver can feel haptic feedbacks through buttocks and/or thighs. The haptics from driver seat may alone are in combination with haptics of steering wheel can provide desired feedback to the driver.

A graphical user interface (GUI) provided via central console, Infotainment system or by a connected smartphone/smart device enables a user to enable or disable haptic feedbacks, adjust the level of haptic feedback, or selecting input and output parameters for haptics feedback.

The present invention provides haptic feedback via steering wheel of the vehicle, wherein haptic feedback is related to vehicle's traveling conditions including speed, torque, acceleration, traction, drift, road surface, etc. Also, the haptics can emulate vibrations similar to older generation vehicles in modern vehicles having better isolated cabin for NVH levels. Further, the haptics can emulate vibrations similar to internal combustion engine vehicle in an electric vehicle (EV).

To summarize, embodiments of the present invention relates to a haptic system, for a steering wheel in a vehicle, for providing situationally-aware alerts. The haptic system includes one or more sensors positioned on the vehicle and configured to sense at least one parameter associated with the vehicle, while the vehicle is being driven; a control unit communicably coupled with the one or more sensors to retrieve the at least one sensed parameter and generate at least one trigger signal based on the at least one sensed parameter; and one or more vibration generators communicably coupled with the control unit, the one or more vibration generators are configured in the steering wheel and are configured to generate vibrations in the steering wheel based on the at least one trigger signal generated by the control unit, the vibrations corresponds to the situationally-aware alerts; wherein the vibrations caused by the one or more vibration generators are proportional to the at least one sensed parameter and emulates vibration of a traditional vehicle for the at least one sensed parameter.

In an embodiment, the at least one parameters are associated with operations parameters of the vehicle, while the vehicle is being driven, wherein the operations parameters are selected from any or a combination of an engine/motor/ drivetrain torque, an engine RPM (rotation per minute), an acceleration/speed of the vehicle.

In another embodiment, the at least one parameters are associated with traction experienced by at least one wheel of the vehicle or vertical movement of at least one wheel of the vehicle or one or more external conditions associated with vehicle, the one or more external conditions selected from any or a combination of a road surface, weather condition, object detection, proximity of another vehicle, diversion of path of the vehicle from its intended path, undulations, road smoothness or roughness, topography of road section, road material like tarmac, gravels, grass, snow, sand, and grip of the tires (traction, wheel slip, lateral wheel slip etc.).

In an embodiment, each of the one or more vibration generators are configured to generate vibrations in synchronous manner.

In another embodiment, each of the one or more vibration generators are configured to generate vibrations in asynchronous manner.

In an embodiment, each of the one or more vibration generators are configured inside a rim of the steering wheel, wherein each of the one or more vibration generators are separated by a distance from each other and create vibrations at a small area of surface of steering wheel.

In an embodiment, at least one of the one or more vibration generators is configured inside a rim of the steering wheel.

In an embodiment, the control unit, upon generation of the trigger signal, generates another signal to be transmitted to an electronic control unit (ECU) of the vehicle to take at least one control measure based on the at least one sensed parameter.

In an embodiment, the one or more vibration generators are selected from any or a combination of a vibration generator transducer, an Eccentric rotating mass vibration motor (ERM), a Linear resonant actuator (LRA), and Piezoelectric haptic generators/actuators.

In an embodiment, at least one of the one or more vibration generators are configured in a seat of a driver of the vehicle or near accelerator of the vehicle

Another embodiment of the present invention relates to a method for providing situationally-aware alerts implemented by a haptic system for a steering wheel in a vehicle. The method includes sensing, by one or more sensors positioned on the vehicle, at least one parameter associated with the vehicle, while the vehicle is being driven; retrieving, by a control unit communicably coupled with the one or more sensors, the at least one sensed parameter and generating at least one trigger signal based on the at least one sensed parameter; generating, by one or more vibration generators communicably coupled with the control unit, vibrations in the steering wheel based on the at least one trigger signal generated by the control unit, the vibrations corresponds to the situationally-aware alerts, the one or more vibration generators are configured in the steering wheel; wherein the vibrations caused by the one or more vibration generators are proportional to the at least one sensed parameter and emulates vibration of a traditional vehicle for the at least one sensed parameter.

In an embodiment, the method also includes the step of generating, by the control unit upon generation of the trigger signal, another signal to be transmitted to an electronic control unit (ECU) of the vehicle to take at least one control measure based on the at least one sensed parameter.

Another embodiment of the present invention relates to a haptic system, for a steering wheel in a vehicle, for providing situationally-aware alerts. The haptic system includes one or more sensors positioned on the vehicle and configured to sense at least one parameter associated with the vehicle, while the vehicle is being driven; a control unit communicably coupled with the one or more sensors to retrieve the at least one sensed parameter and generate at least one trigger signal based on the at least one sensed parameter; and one or more vibration generators communicably coupled with the control unit, the one or more vibration generators are configured in the steering wheel and are configured to generate vibrations in the steering wheel, in a synchronous manner or in an asynchronous manner, based on the at least one trigger signal generated by the control unit, the vibrations corresponds to the situationally-aware alerts; wherein the vibrations caused by the one or more vibration generators are proportional to the at least one sensed parameter and emulates vibration of a traditional vehicle for the at least one sensed parameter.

Even though the invention is described for car like vehicle, however, the invention can be implemented in any vehicle such as motor-bike, truck, lorry, air-craft etc. The invention is not limiting to the steering wheel but can be used in steering wheels for computer games (game controller) where haptics provides more realistic feedback for in game parameters. The invention can also be used in aircraft control sticks/joysticks/control-yoke/side-sticks, where the forces at various aircraft surfaces (wings and rudder) are sensed and emulated by vibration motor arrays mounted in the aircraft control stick.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

1. A haptic system, for a steering wheel in a vehicle, for providing situationally-aware alerts, the haptic system comprising:
one or more sensors positioned on the vehicle and configured to sense at least one parameter associated with the vehicle, while the vehicle is being driven;
a control unit communicably coupled with the one or more sensors to retrieve the at least one sensed parameter and generate at least one trigger signal based on the at least one sensed parameter; and
one or more vibration generators communicably coupled with the control unit, the one or more vibration generators are configured in the steering wheel and are configured to generate vibrations in the steering wheel based on the at least one trigger signal generated by the control unit, the vibrations corresponds to the situationally-aware alerts;
wherein the vibrations caused by the one or more vibration generators are proportional to the at least one sensed parameter and emulates vibration of a traditional vehicle for the at least one sensed parameter.

2. The haptic system of claim 1, wherein the at least one parameters are associated with operations parameters of the vehicle, while the vehicle is being driven, wherein the operations parameters are selected from any or a combination of an engine/motor/ drivetrain torque, an engine RPM (rotation per minute), an acceleration/speed of the vehicle.

3. The haptic system of claim 1, wherein the at least one parameters are associated with traction experienced by at least one wheel of the vehicle or vertical movement of at least one wheel of the vehicle or one or more external conditions associated with vehicle, the one or more external conditions selected from any or a combination of a road surface, weather condition, object detection, proximity of another vehicle, diversion of path of the vehicle from its intended path, undulations, road smoothness or roughness, topography of road section, road material like tarmac, gravels, grass, snow, sand, and grip of the tires (traction, wheel slip, lateral wheel slip etc.).

4. The haptic system of claim 1, wherein each of the one or more vibration generators are configured to generate vibrations in synchronous manner.

5. The haptic system of claim 1, wherein each of the one or more vibration generators are configured to generate vibrations in asynchronous manner.

6. The haptic system of claim 1, wherein each of the one or more vibration generators are configured inside a rim of the steering wheel, wherein each of the one or more vibration generators are separated by a distance from each other and create vibrations at a small area of surface of steering wheel.

7. The haptic system of claim 1, wherein at least one of the one or more vibration generators is configured inside a rim of the steering wheel.

8. The haptic system of claim 1, wherein the control unit, upon generation of the trigger signal, generates another signal to be transmitted to an electronic control unit (ECU) of the vehicle to take at least one control measure based on the at least one sensed parameter.

9. The haptic system of claim 1, wherein the one or more vibration generators are selected from any or a combination of a vibration generator transducer, an Eccentric rotating mass vibration motor (ERM), a Linear resonant actuator (LRA), and Piezoelectric haptic generators/actuators.

10. The haptic system of claim 1, wherein at least one of the one or more vibration generators are configured in a seat of a driver of the vehicle or near accelerator of the vehicle.

11. A method for providing situationally-aware alerts implemented by a haptic system for a steering wheel in a vehicle, the method comprising:
sensing, by one or more sensors positioned on the vehicle, at least one parameter associated with the vehicle, while the vehicle is being driven;
retrieving, by a control unit communicably coupled with the one or more sensors, the at least one sensed parameter and generating at least one trigger signal based on the at least one sensed parameter;
generating, by one or more vibration generators communicably coupled with the control unit, vibrations in the steering wheel based on the at least one trigger signal generated by the control unit, the vibrations corresponds to the situationally-aware alerts, the one or more vibration generators are configured in the steering wheel;
wherein the vibrations caused by the one or more vibration generators are proportional to the at least one sensed parameter and emulates vibration of a traditional vehicle for the at least one sensed parameter.

12. The method of claim 11, further comprising: generating, by the control unit upon generation of the trigger signal, another signal to be transmitted to an electronic control unit (ECU) of the vehicle to take at least one control measure based on the at least one sensed parameter.

13. A haptic system, for a steering wheel in a vehicle, for providing situationally-aware alerts, the haptic system comprising:
one or more sensors positioned on the vehicle and configured to sense at least one parameter associated with the vehicle, while the vehicle is being driven;
a control unit communicably coupled with the one or more sensors to retrieve the at least one sensed parameter and generate at least one trigger signal based on the at least one sensed parameter; and
one or more vibration generators communicably coupled with the control unit, the one or more vibration generators are configured in the steering wheel and are configured to generate vibrations in the steering wheel, in a synchronous manner or in an asynchronous manner, based on the at least one trigger signal generated by the control unit, the vibrations corresponds to the situationally-aware alerts;
wherein the vibrations caused by the one or more vibration generators are proportional to the at least one sensed parameter and emulates vibration of a traditional vehicle for the at least one sensed parameter.
